(19) United States
(12) Patent Application Publication
(10) Pub. No.: US 2015/0300165 A1
(43) Pub. Date: Oct. 22, 2015

(54) ROTARY CUTTER SYSTEM FOR MACHINES

(71) Applicant: CATERPILLAR PAVING PRODUCTS INC., Brooklyn Park, MN (US)

(72) Inventor: John L Marsolek, Watertown, MN (US)

(73) Assignee: CATERPILLAR PAVING PRODUCTS INC., Brooklyn Park, MN (US)

(21) Appl. No.: 14/791,547

(22) Filed: Jul. 6, 2015

(51) Int. Cl. E21C 35/18; E01C 23/12; E21C 25/10; G06K 7/10

(52) U.S. Cl. CPC E21C 35/18; G06K 7/10366; E01C 23/12; E21C 25/10

(57) ABSTRACT

A rotary cutter system for a machine is disclosed. The rotary cutter system includes a drum, a plurality of cutting tools, a radio-frequency identification (RFID) tag associated with each of the plurality of cutting tools, an RFID reader, and a controller. The cutting tools are removably coupled to the drum through a plurality of tool holders. Each cutting tool is removably supported in a tool holder. The RFID reader is in wireless communication with each RFID tag of each cutting tool. The controller is in electrical communication with the RFID reader and generates a signal in response to at least one RFID tag being disconnected from the RFID reader corresponding to at least one cutting tool being separated from the tool holder.

### TECHNICAL FIELD

The present disclosure relates generally to rotary cutter systems for machines. More specifically, the present disclosure relates to a rotary cutter system for machines, which has replaceable cutting tools.

### BACKGROUND

Various machines, such as cold planers, are commonly known to employ a rotary cutter system, to perform milling operations on a work surface. The rotary cutter system generally facilitates removal of a paved area on the work surface, such as a paved area laid over a road, a bridge, and/or a parking area. Commonly, the rotary cutter system includes a drum, which contains rows of tool holders. Each tool holder receives a cutting tool therein. Customarily, the drum is driven by a motor at a high rate of rotation and the cutting tools, which are fixed to the drum within their tool holders, impact the work surface as the rotating drum is lowered and brought into contact with the work surface. As the cutting tools contact the work surface, pieces or fragments of pavement are spun off and the pavement is removed through successive passes of the cutting tools of the rotary cutter system. The spun off particles are directed to an enclosed portion of a cutter enclosure which generally encloses the cutting tools. The particles are generally directed towards the center of the machine within this cutter enclosure and are loaded onto the machine's conveyor belt to be loaded onto a haul vehicle to be hauled away. Cutting tools are subject to extreme abrasion and impact and may become loose or may break off during operation of the rotary cutter system. The loss of one or more of the cutting tools from the tool holders fixed to the drum causes a decrease in productivity and if not addressed the tool holders and the drum may be subjected to damage and loss. Once the tool holders or the drum is damaged, the expense to replace one or more of these components is significant and typically the downtime associated with such service operation is significant. With many machines, the operator is left to periodically stop the machine and visually inspect the rotary cutter system for missing cutting tools, which is time consuming and if not regularly checked then the tool holders and the drum may become damaged.

In conventional inspection practices, generally, the rotary cutter system is lifted off the work surface and physically inspected by an operator. In so doing, it is determined if a need for replacement of the cutting tools is required. The operator may count the number of cutting tools that are broken or missing from the tool holders and then seek to replace the broken or missing cutting tools. This service operation is cumbersome and reduces the productivity of the operation. Moreover, it is often difficult to know when to conduct the inspection, and checking too often will reduce machine productivity, however infrequent inspections may lead to machine down time and expense.

PCT Application WO 2,012,116,408 discloses a detection system to detect the loss of a ground-engaging tool component from a mining or earth-moving machine. Although, this reference discusses detection of loss of ground-engaging tools, room remains to further simplify and lessen bulk of a system that tracks ground-engaging tools.

### SUMMARY OF THE INVENTION

Various aspects of the present disclosure are directed towards a rotary cutter system for a machine. The rotary cutter system includes a drum, a plurality of cutting tools, a radio-frequency identification (RFID) tag associated with each cutting tool of the plurality of cutting tools, an RFID reader, and a controller. The cutting tools are removably coupled to the drum through a plurality of tool holders. Each cutting tool of the plurality of cutting tools being removably supported in a tool holder of the plurality of tool holders. The RFID reader is in wireless communication with each RFID tag of each cutting tool of the plurality of cutting tools. The controller is in electrical communication with the RFID reader and generates a signal in response to at least one that indicates that at least one RFID tag being disconnected from the RFID reader corresponding to at least one cutting tool being separated from the tool holder. This facilitates the rotary cutter system to compute and provide the total number of cutting tools present on the drum at a given point of time.

### BRIEF DESCRIPTION OF THE DRAWINGS

FIG. 1 is a side view of an exemplary machine installed with a rotary cutter system, in accordance with the concepts of the present disclosure;

FIG. 2 is a partial perspective view of the rotary cutter system of FIG. 1 that illustrates a drum and a number of cutting tools positioned on the drum, in accordance with the concepts of the present disclosure;

FIG. 3 is a magnified view of one of the cutting tools of the rotary cutter system of FIG. 2, in accordance with the concepts of the present disclosure;

FIG. 4 is a block diagram of a tool tracker unit to inspect and/or track the cutting tools of the rotary cutter system of FIG. 2, in accordance with the concepts of the present disclosure; and

FIG. 5 is a flow chart of a method to track the cutting tools of the rotary cutter system of FIG. 2, in accordance with the concepts of the present disclosure.

### DETAILED DESCRIPTION

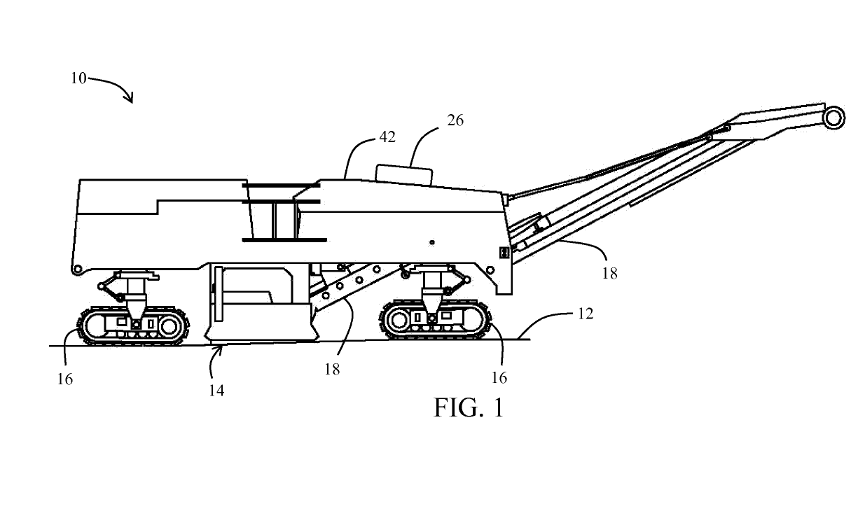

Referring to FIG. 1, there is shown a machine 10. The machine 10, such as a cold planer, is adapted to perform milling operations on a work surface 12. The machine 10 generally includes a rotary cutter system 14, to perform the milling operation on the work surface 12. For example, the rotary cutter system 14 is adapted to remove a paved area laid over the work surface 12, such as a paved area laid over a road, a bridge, and/or a parking area. Although the cold planer is shown as a preferred embodiment of the machine 10 in the present disclosure, it may be noted that the machine 10 may be any construction machinery that includes the rotary cutter system 14. For example, concepts of the present disclosure may also be applied to a rotary mixer machine.

The rotary cutter system 14 is rotatably supported on a frame (not shown) of the machine 10. The rotary cutter system 14 is capable of being elevated and lowered, respectively to disengage and engage with the work surface 12. To facilitate the milling operation, the rotary cutter system 14 is lowered and rotated over the work surface 12, which causes at least a portion of the work surface 12 to be broken and removed from the work surface 12. Moreover, the machine 10 includes a plurality of drive units 16, which facilitate the machine 10 to travel along a length of the work surface 12 and perform the milling operation on the entire length of the work surface 12. The rotary cutter system 14 is positioned adjacent to a set of conveyor units 18 of the machine 10, such that the milled particles are spun off and transferred to a truck (not shown) through the set of conveyor units 18 of the machine 10.

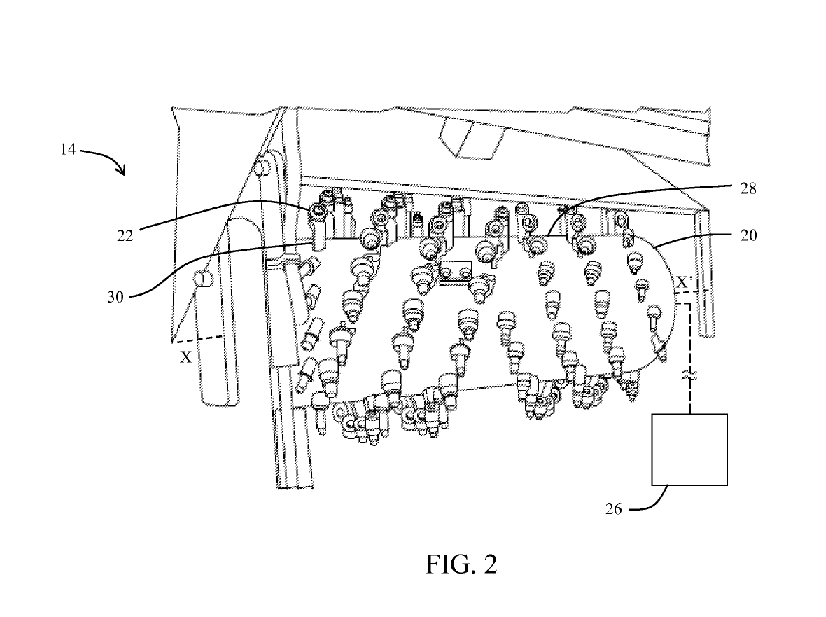

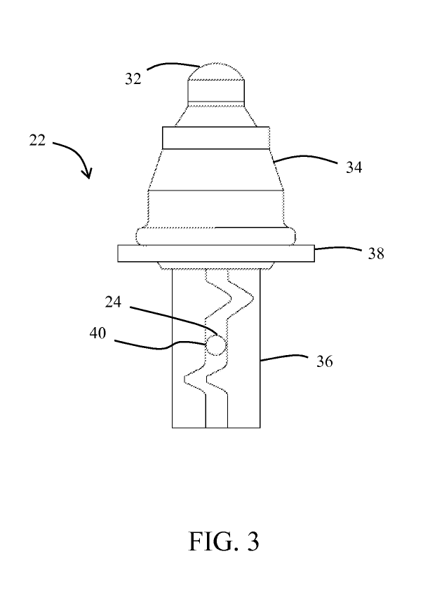

Referring to FIG. 2, there is shown the rotary cutter system 14 of the machine 10. The rotary cutter system 14 includes a drum 20, a number of cutting tools 22, a number of radio frequency identification (RFID) tags 24 (FIG. 3), and a tool tracker unit 26.

The drum 20 of the rotary cutter system 14 may be a cylindrical member rotatably supported on the frame (not shown) of the machine 10, along a longitudinal axis X-X′. The drum 20 includes a peripheral portion 28 and a multiplicity of tool holders 30 attached to the peripheral portion 28. More specifically, the tool holders 30 are welded to the peripheral portion 28, such that each of the tool holders 30 is positioned tangentially on the peripheral portion 28 of the drum 20. In general, the tool holders 30 are spirally arranged on the peripheral portion 28 of the drum 20 along the longitudinal axis X-X. Although, the tool holders 30 are described as welded to the peripheral portion 28, it may be contemplated that the tool holders 30 may be attached to the peripheral portion 28 by any of the known attachment means, such as but not limited to, a bolt attachment, a rivet attachment, and/or an adhesive attachment. In an embodiment, the tool holders 30 may be an integral component of the drum 20.

The cutting tools 22 herein refers to cutting tool bits that include a carbide tip 32 (FIG. 3) required to perform the cutting operation on the work surface 12. Each cutting tool 22 among the cutting tools 22 is removably attached to a tool holder 30 among the tool holders 30 of the drum 20. Therefore, the cutting tools 22 are also spirally arranged on the drum 20, along the longitudinal axis X-X′. The cutting tools 22 are adapted to rotate along with the drum 20 and make a contact with the work surface 12, to perform the cutting operation. The structure and arrangement of the cutting tools 22 is best described in FIG. 3.

Referring to FIG. 3, there is shown a singular cutting tool 22 among the number of cutting tools 22. Moreover, a singular RFID tag 24 among the number of RFID tags 24 of the tool tracker unit 26 is also shown in FIG. 3. Although, structure and arrangement of the singular cutting tool 22 and the singular RFID tag 24 is described in FIG. 3, similar arrangements for the remaining cutting tools 22 and the remaining RFID tags 24, may also be contemplated. The cutting tool 22 includes a cutting tip portion 34, a shank portion 36, and a stopper portion 38. The stopper portion 38 is positioned between the cutting tip portion 34 and the shank portion 36. The cutting tip portion 34 includes the carbide tip 32 responsible for the cutting action of the cutting tool 22. The shank portion 36 of the cutting tool 22 is removably attached to a tool holder 30 among the number of tool holders 30 of the drum 20. Additionally, the shank portion 36 of the cutting tool 22 includes a tag-receiving portion 40 to receive the RFID tag 24.

The RFID tag 24 is an active tag fixedly attached to the tag-receiving portion 40 of the cutting tool 22 of the rotary cutter system 14. The RFID tag 24 is adapted to store informational data associated with the cutting tool 22. The informational data may include, but is not limited to, a unique tool number, date of manufacturing of the cutting tool 22, manufacturer of the cutting tool 22, and/or the like, by which the cutting tool 22 may be identified. Moreover, the RFID tag 24 is adapted to periodically transmit the informational data associated with the cutting tool 22 to the tool tracker unit 26.

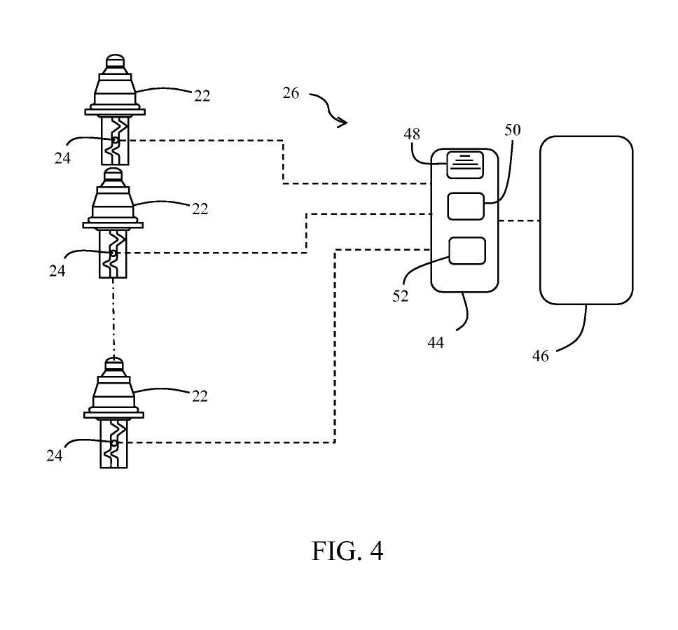

Referring to FIG. 4, there is shown a block diagram of the tool tracker unit 26 of the rotary cutter system 14, connected to the RFID tags 24 of a number of cutting tools 22. As shown in FIG. 1, the tool tracker unit 26 is mounted on a roof 42 of the machine 10 and is adapted to track the cutting tools 22 of the rotary cutter system 14. However, a different mounting space, such as being relatively closer to the drum 20, may be contemplated. The tool tracker unit 26 includes an RFID reader 44 and a controller 46.

The RFID reader 44 may be a transceiver device in wireless communication to each RFID tags 24 of each cutting tool 22 of the rotary cutter system 14. The RFID reader 44 includes an antenna 48, a receiver 50, and a transmitter 52. Notably, a connection between an RFID tag 24 and the RFID reader 44 is maintained, if the RFID tag 24 is within a range of the antenna 48 of the RFID reader 44. Similarly, an RFID tag 24 is disconnected from the RFID reader 44, if the RFID tag 24 is beyond the range of the antenna 48 of the RFID reader 44. The receiver 50 of the RFID reader 44 receives the informational data from the RFID tags 24 that are connected to the RFID reader 44 and are within the range of the antenna 48. The transmitter 52 of the RFID reader 44 transmits the informational data received by the RFID reader 44 to the controller 46.

The controller 46 may be a microcontroller unit electrically connected to the RFID reader 44. The controller 46 includes a memory unit that stores a predetermined data associated with the cutting tools 22 of the rotary cutter system 14. The controller 46 is adapted to compare the informational data received from the RFID reader 44 with predetermined data. Based on the comparison, the controller 46 is adapted to determine whether each of the RFID tags 24 is connected to the RFID reader 44 and correspondingly whether each of the cutting tools 22 is connected to the tool holder 30 of the drum 20. More specifically, if the informational data received from the RFID reader 44 matches the predetermined data, the controller 46 determines that each of the RFID tags 24 is connected to the RFID reader 44 and correspondingly each of the cutting tools 22 is attached to the tool holder 30 of the drum 20. Similarly, if the informational data received from the RFID reader 44 mismatches the predetermined data, the controller 46 determines that at least one RFID tag 24 is disconnected from the RFID reader 44 and at least one cutting tool 22 is separated from the tool holder 30 of the drum 20. The controller 46 is adapted to generate a signal in response to at least one RFID tag 24 being disconnected from the RFID reader 44 and at least one cutting tool 22 being separated from the tool holder 30. The signal may be one or more of a voice signal, an LED indicator signal, a breakdown signal, and/or the like.

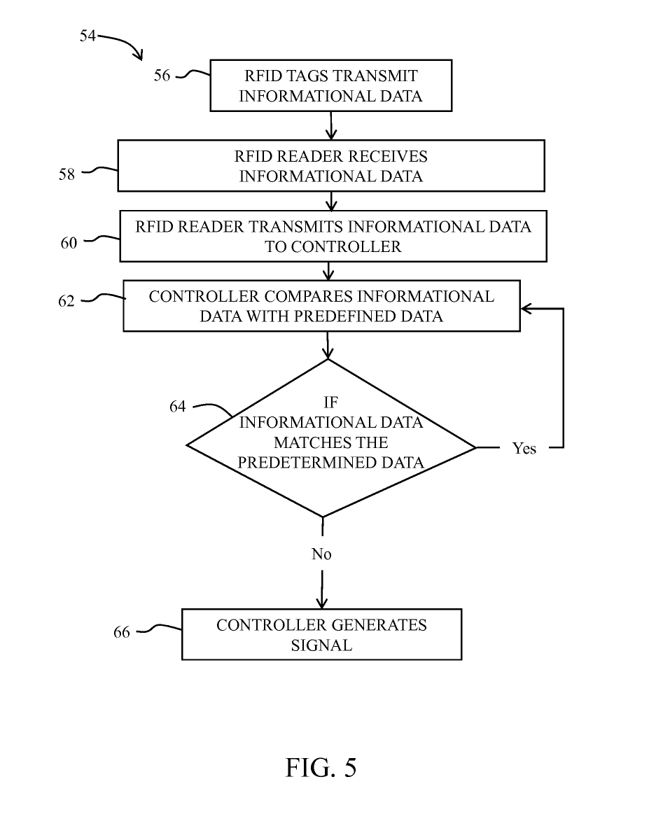

Referring to FIG. 5, there is shown a flow chart of a method 54 followed by the rotary cutter system 14 to generate the signal (alarm). The method 54 initiates at step 56. At step 56, the RFID tags 24 of each of the cutting tools 22 transmit informational data associated with the corresponding cutting tools 22. The method 54 then proceeds to step 58.

At step 58, the RFID reader 44 receives the informational data from the RFID tags 24 of the cutting tools 22, which are connected to the RFID reader 44 and are within the range of the antenna 48 of the RFID reader 44. Notably, the RFID reader 44 is unable to receive the informational data if the RFID tags 24 are beyond the range of antenna 48 of the RFID reader 44. The method 54 then proceeds to step 60.

At step 60, the RFID reader 44 transmits the informational data of the RFID tags 24 to the controller 46. Notably, the informational data of only those RFID tags 24, which are within the range of the antenna 48, is transmitted to the controller 46. The method 54 then proceeds to step 62.

At step 62, the controller 46 compares the informational data with a predefined data. The predefined data may be an array of data that corresponds to each of the cutting tools 22 of the rotary cutter system 14. The method 54 then proceeds to step 64. The method 54 then proceeds to step 64.

At step 64, the controller 46 determines whether each of the RFID tags 24 is connected to the RFID reader 44 and each of the cutting tool 22 is attached to the tool holder 30 of the drum 20. More specifically, if the informational data matches the predetermined data, the controller 46 determines that each of the RFID tags 24 is connected to the RFID reader 44 and each of the cutting tool 22 is attached to the tool holder 30 of the drum 20. However, if the informational data mismatches the predetermined data, the controller 46 determines that at least one RFID tag 24 is disconnected from the RFID reader 44 and at least one cutting tool 22 is no longer attached to the tool holder 30 of the drum 20. If the informational data mismatches the predetermined data, the method 54 proceeds to step 66.

At end step 66, the controller 46 generates the signal indicating that at least one cutting tool 22 is separated from the tool holder 30 of the drum 20.

### INDUSTRIAL APPLICABILITY

In operation, the rotary cutter system 14 rotates over a work surface 12 and facilitates a contact of the cutting tools 22 with the work surface 12. In so doing, the rotary cutter system 14 facilitates a removal of at least a portion of the work surface 12. As a result, the work surface 12 may be broken into pieces and removed. In the current embodiment, the cutting tools 22 are tracked and/or inspected for breakage and detachment from the drum 20 with the concerted use of the RFID tags 24, the RFID reader 44, and the controller 46. Notably, the RFID tags 24, the RFID reader 44, and the controller 46 may be continually and/or periodically actuated during the cutting operation of the machine 10.

The RFID tags 24 transmit informational data associated with each of the cutting tools 22. This transmission may be periodically enabled. The RFID reader 44 receives the informational data from the RFID tags 24 of those cutting tools 22 that are connected to the RFID reader 44 and are within the range of the antenna 48. Thereafter, the RFID reader 44 transmits the informational data of the cutting tools 22 to the controller 46 of the rotary cutter system 14.

After receipt of the informational data from the RFID reader 44, the controller 46 compares the informational data of the cutting tools 22 with the predetermined data. Based on the comparison, the controller 46 determines whether each of the RFID tags 24 are connected to the RFID reader 44 and whether each of the cutting tools 22 is attached to the tool holder 30 of the drum 20. If the informational data matches the predetermined data, the controller 46 determines that each of the RFID tags 24 is connected to the RFID reader 44 and each of the cutting tool 22 is attached to the tool holder 30 of the drum 20. However, if the informational data mismatches the predetermined data, the controller 46 determines that at least one RFID tag 24 is disconnected from the RFID reader 44 and at least one cutting tool 22 is no longer attached to the tool holder 30 of the drum 20. The controller 46 generates a signal in response to at least one RFID tag 24 is disconnected from the RFID reader 44 and at least one cutting tool 22 is no longer attached to the tool holder 30 of the drum 20.

In an embodiment, the controller 46 determines a number of RFID tags 24 disconnected from the RFID reader 44 and correspondingly a number of cutting tools 22 that are no longer attached to the drum 20. The controller 46 generates a notification (or an alarm), when the number of cutting tools 22 that are broken off from the drum 20, breaches a threshold value. The notification may notify an operator to service the rotary cutter system 14.

In effect, the rotary cutter system 14 facilitates automatic inspection and/or track of the cutting tools 22 of the rotary cutter system 14 by use of the RFID tags 24, the RFID reader 44, and the controller 46. As the rotary cutter employs relatively lesser components for inspection and/or tracking of the cutting tools 22 of the rotary cutter system 14, the rotary cutter system 14 may be relatively less bulky. Moreover, the rotary cutter system 14 notifies the operator when a replacement of one or more of the cutting tools 22 is imperative. This reduces the complexity and/or effort for the operator to inspect and/or replace the cutting tools 22 of the rotary cutter system 14.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A rotary cutter system for a machine, comprising:
a drum;
a plurality of cutting tools removably coupled to the drum through a plurality of tool holders, wherein each cutting tool of the plurality of cutting tools being removably supported in a tool holder of the plurality of tool holders;
a radio-frequency identification (RFID) tag associated with each cutting tool of the plurality of cutting tools;
an RFID reader in communication with each RFID tag of each cutting tool of the plurality of cutting tools; and
a controller in communication with the RFID reader, wherein the controller being configured to generate a signal in response to at least one RFID tag being disconnected from the RFID reader corresponding to at least one cutting tool being separated from the tool holder.
